(19) United States
(12) Patent Application Publication
(10) Pub. No.: US 2017/0226277 A1
(43) Pub. Date: Aug. 10, 2017

(54) HARDENER COMPOSITION

(71) Applicant: BLUE CUBE IP LLC, Midland, MI (US)

(72) Inventors: MARKUS SCHROETZ, Baltringen (DE); EVA-MARIA MICHALSKI, Rheinmuenster (DE); MARCUS PFARHERR, Baltringen (DE); JUERGEN GAEBEL, Laupheim (DE)

(21) Appl. No.: 15/320,528

(22) PCT Filed: Jun. 25, 2015
(86) PCT No.: PCT/US2015/037640

§ 371 Date: Dec. 20, 2016

Related U.S. Application Data
(60) Provisional application No. 62/019,680, filed on Jul. 1, 2014.

(51) Int. Cl. C08G 59/50; C08G 59/24; C08K 5/05

(52) U.S. Cl. CPC C08G 59/5026; C08K 5/05; C08G 59/245

(57) ABSTRACT

A hardener composition including: (a) a polymeric adduct; (b) a monomeric unmodified amine; and (c) an extender; a curable composition including (A) at least one epoxy compound; and (B) the above hardener composition; and a thermoset prepared from the above curable composition.

### FIELD

The present invention is related to a hardener composition and to a curable epoxy resin composition containing such hardener composition. The curable composition of the present invention is useful for preparing cured thermoset articles including for example syntactic foam.

### BACKGROUND

Various combinations of epoxy resins and hardeners for producing curable epoxy resin compositions are well known in the art. Also, syntactic foams using epoxy resins or other binders are disclosed in RU 2489264 and GB 1377974. In addition, EP 1769032 B1 discloses combining polyoxyalkylenamines with aliphatic amines wherein the combination is used as hardeners for foams. However, nothing in the above prior art provides an epoxy resin/hardener system or composition that can be used to produce thick thermoset layers (e.g., layers having a thickness of greater than [>] 10 centimeters [cm]) and/or big thermoset modules (e.g., modules having a volume size of >200 liters [L]) of syntactic foam in a single step. Therefore, it would be a great improvement in the industry to provide a hardener and curable epoxy resin composition that can be used to manufacture cured thermoset articles such as syntactic foam with superior properties.

### SUMMARY

One embodiment of the present invention is directed to a hardener formulation or composition including a reaction product of the following compounds: (a) a polymeric adduct, such as a polymeric adduct made from a polyalkylenepolyamine and a liquid epoxy resin (LER); (b) an amine such as a monomeric cycloaliphatic polyamine; and (c) an extender/modifier material such as an aliphatic long chain difunctional diol including for example fatty mono or di-alcohols. Surprisingly, it has been found that the unique mixture comprising the above components (a), (b), and (c) yields a hardener composition with several beneficial properties. For example, the hardener composition of the present invention exhibits: (1) a reactivity level of greater than or equal to (≧) 90 percent (%) and (2) a peak exotherm temperature of >160 degrees Celsius (° C.).

Another embodiment of the present invention is directed to a curable composition including an epoxy resin and the above novel hardener composition of the present invention. One advantage of using the above hardener composition, as compared to a conventional hardener, is that upon curing an epoxy resin containing the hardener composition of the present invention to form a cured thermoset material, the resultant cured thermoset material maintains a balance of properties including for example a glass transition temperature (Tg) of >75° C.

Still another embodiment of the present invention is directed to a thermoset article prepared from the above curable composition including for example a syntactic foam article.

Yet other embodiments of the present invention include processes for preparing the above hardener composition, the above curable composition and the above cured thermoset article.

### BRIEF DESCRIPTION OF THE DRAWINGS

For the purpose of illustrating the present invention, the drawings show a form of the present invention which is presently preferred. However, it should be understood that the present invention is not limited to the embodiments shown in the drawings.

FIG. 1 is a graphical illustration showing the exothermic characteristic of several compositions containing various hardener compositions. FIG. 1 shows the temperature versus the time to determine peak max temperature of the composition.

### DETAILED DESCRIPTION

In its broadest scope, the present invention includes a hardener composition or formulation including at least three components such as the following compounds:

(a) a polymeric adduct;

(b) a monomeric unmodified amine; and

(c) an extender.

The above hardener mixture can be made, for example, from a mixture of from about 40 weight percent (wt %) to about 90 wt % polymeric adduct component (a), from about 20 wt % to about 5 wt % monomeric unmodified amine component (b), and from about 20 wt % to about 5 wt % extender component (c) yielding a hardener mixture with several advantages described herein.

The polymeric adduct, component (a) or the first component of the three-component hardener formulation or composition, includes for example various known polymeric adducts such as adducts from a polyoxyalkylenepolyamine with an epoxy resin compound.

In one preferred embodiment, the polymeric adduct useful in forming the hardener of the present invention can be a reaction product of at least two components such as the following compounds: (i) a polyoxyalkylenepolyamine such as a polyoxyethylenediamine, and (ii) an epoxy resin compound such as a bisphenol A diglycidylether. Optional compounds can be added to the above polyoxyalkylenepolyamine, components (i), and the above epoxy resin compound, component (ii), as desired to make the polymeric adduct.

In general, the polyoxyalkylenepolyamine, component (i), used to produce the polymeric adduct can include the polyoxyethylene, polyoxypropylene, or polyoxybutylene of mono-, di- or tri-amines, or mixtures thereof. The alkylene oxide backbone may also vary within the polymer chain.

In yet another embodiment, examples of some commercial polyalkylenepolyamines useful in the present invention include for example Polyetheramine 230 (also known as “Jeffamine D-230”); polyethylenepolyamines such as “D-400” and “D-2000”; and T403; and mixtures thereof.

Generally, the amount of polyalkylenepolyamine, component (i), used in preparing the polymeric adduct, may be for example, from about 50 wt % to about 90 wt % in one embodiment, from about 60 wt % to about 85 wt % in another embodiment; and from about 70 wt % to about 80 wt % in still another embodiment, based on the total weight of the curable composition.

The epoxy resin compound, component (ii), used to produce the polymeric adduct can include one epoxy compound or a combination of two or more epoxy compounds. For example, the epoxy compound useful in the present invention may include any conventional epoxy compound. One embodiment of the epoxy compound or compounds used to produce the polymeric adduct, may be for example epoxy compounds known in the art such as any of the epoxy resin compounds described in Lee, H. and Neville, K., Handbook of Epoxy Resins, McGraw-Hill Book Company, New York, 1967, Chapter 2, pages 2-1 to 2-27, incorporated herein by reference.

In a preferred embodiment, the epoxy compound may include for example epoxy resins based on reaction products of polyfunctional alcohols, phenols, cycloaliphatic carboxylic acids, aromatic amines, or aminophenols with epichlorohydrin. A few non-limiting embodiments include, for example, bisphenol A diglycidyl ether, bisphenol F diglycidyl ether, resorcinol diglycidyl ether, and triglycidyl ethers of para-aminophenols. Other suitable epoxy resins known in the art include for example reaction products of epichlorohydrin with o-cresol novolacs, hydrocarbon novolacs, and, phenol novolacs.

The epoxy resin compound may also be selected from commercially available epoxy resin products such as for example, D.E.R. 331®, D.E.R. 332, D.E.R. 354, D.E.R. 580, D.E.N. 425, D.E.N. 431, D.E.N. 438, D.E.R. 736, or D.E.R. 732 epoxy resins available from The Dow Chemical Company. In one preferred embodiment, the epoxy compound, component (ii), used to produce the polymeric adduct can include for example, a bisphenol A diglycidylether such as D.E.R.™331 commercially available from The Dow Chemical Company.

Generally, the amount of the epoxy resin compound, component (ii), used in preparing the polymeric adduct, may be for example, from about 10 wt % to about 50 wt % in one embodiment, from about 15 wt % to about 40 wt % in another embodiment; and from about 20 wt % to about 30 wt % in still another embodiment, based on the total weight of the curable composition.

The polymeric adduct is prepared by reacting the polyalkylenepolyamine, component (i) described above, with an epoxy resin compound, component (ii) described above, under reaction conditions such that a useful polymeric adduct is formed. For example, all of the components used to prepare the polymeric adduct are typically mixed and dispersed at a temperature enabling the preparation of an effective polymeric adduct. For example, the temperature during the mixing of all components may be generally from about 60° C. to about 160° C. in one embodiment; from about 70° C. to about 150° C. in another embodiment; and from about 80° C. to about 140° C. in still another embodiment.

The preparation of the polymeric adduct useful in the present invention, and/or any of the steps thereof, may be a batch or a continuous process. The mixing equipment used in the process may be any vessel and ancillary equipment well known to those skilled in the art.

Once the polymeric adduct is formed, the amount of polymeric adduct used as component (a) in the hardener composition of the present invention, generally may be for example, from about 60 wt % to about 90 wt % in one embodiment, from about 70 wt % to about 90 wt % in another embodiment; and from about 80 wt % to about 90 wt % in still another embodiment, based on the total weight of the components in the hardener composition.

Another component, component (b), of the hardener composition includes a monomeric unmodified amine A “monomeric unmodified amine”, with reference to the hardener composition, herein means an aliphatic or cycloaliphatic di or polyamine.

In general, the monomeric unmodified amine, component (b), of the hardener composition, includes for example a monomeric unmodified aliphatic amine, a monomeric unmodified araliphatic amine, a monomeric unmodified cycloaliphatic amine and mixtures thereof. In a preferred embodiment, the amine can include for example isophoronediamine, trimethylhexamethylendiamine 1,3-bisaminomethylcyclohexyldiamine, and mixtures thereof.

Generally, the amount of unmodified amine compound used in preparing the hardener composition of the present invention, may be for example, from about 1 wt % to about 15 wt % in one embodiment, from about 2 wt % to about 12 wt % in another embodiment, and from about 5 wt % to about 10 wt % in still another embodiment, based on the total weight of the compounds in the curable composition.

Another component of the hardener composition of the present invention includes for example an extender (or “modifier”) compound as component (c). In general, the extender is substantially inert, i.e., is substantially unreactive with any of the other compounds (such as the polymeric adduct and unmodified amine) in the hardener composition or the other compounds (such as the epoxy resin and the amine) in the curable composition; and the extender neither accelerates nor retards the epoxy-amine reaction of the curable composition.

Generally, to obtain beneficial results, the extender used in the hardener composition should be a compound, for example, that has no significant deleterious effect on the curing speed of the hardener (e.g., the curing speed of the present invention hardener is maintained at a speed comparable to the curing speed of a conventional hardener; or the difference in curing speed between the present invention hardener and a conventional hardener is at most 5% or less). The extender used in the hardener composition should also be a compound that lowers the peak exotherm temperature of the curing composition during curing (e.g., the peak exotherm of the curing composition is preferably <160° C.). And, the extender used in the hardener composition should also be a compound that maintains the Tg of the thermoset (e.g., a Tg of >about 75° C.) made using the present invention hardener composition (i.e., the Tg of the thermoset made using the present invention hardener composition is comparable to the Tg of a thermoset made using a conventional hardener).

The curing speed of the hardener composition can be measured by any conventional methods known in the art. In the present invention, the curing speed of the hardener can be identified by the peak exotherm temperature of a reacting mixture by the following general procedure: A mixture of the hardener composition and a thermosetting resin (at a ratio of 1 equivalent:1 equivalent, with or without bubbles or extenders/modifiers) is placed into an adiabatic cup at 23° C. A thermocouple is placed in the center of the mixture in the cup and as the mixture cures, the time to reach peak temperature of a reacting mixture is measured.

Generally, the amount of extender compound used in the hardener composition of the present invention, may be for example, from about 1 wt % to about 20 wt % in one embodiment, from about 2 wt % to about 15 wt % in another embodiment; and from about 5 wt % to about 12 wt % in still another embodiment, based on the total weight of the curable composition.

The process of making the hardener composition includes the step of admixing at least (a) a polymeric adduct; (b) a monomeric unmodified amine; and (c) an extender; and any desired optional additives, under mixing conditions such that a hardener composition is formed. The components used to prepare the hardener composition are typically mixed and dispersed at a temperature enabling the preparation of an effective hardener composition. For example, the temperature during the mixing of all components may be generally from about 20° C. to about 100° C. in one embodiment, from about 30° C. to about 90° C. in another embodiment, and from about 40° C. to about 80° C. in still another embodiment.

The preparation of the hardener composition of the present invention, and/or any of the steps thereof, may be a batch or a continuous process. The mixing equipment used in the process may be any vessel and ancillary equipment well known to those skilled in the art.

Some the beneficial properties or characteristics of the hardener composition of the present invention include for example, (1) the hardener composition exhibits the same level of reactivity as that of a conventional hardener, such as a hardener used for example in civil engineering applications (e.g. the reactivity can be from about 15 min to about 120 min); (2) the hardener composition exhibits a peak exotherm temperature than is generally lower than a conventional curing agent (e.g., the peak exotherm can be about <160° C.); and (3) the hardener composition is capable of providing a thermoset with a Tg of >75° C. or the hardener composition is capable of maintaining the Tg of a thermoset or at least minimizing a reduction in the Tg of the thermoset.

The level of reactivity of the hardener composition can be measured by the time to reach peak temperature. The peak exotherm of the hardener composition can be measured by temperature in a 155 g sample, as illustrated for instance in the Examples herein. Generally, the peak exotherm temperature of the hardener composition can be from about 25° C. to about 300° C. in one embodiment, from about 100° C. to about 280° C. in another embodiment, and from about 120° C. to about 180° C. in still another embodiment.

Another broad embodiment of the present invention is directed to providing a curable resin formulation or composition including at least the following compounds: (A) at least one epoxy compound; and (II) the hardener composition of the present invention as described above. Other optional additives known to the skilled artisan can be included in the curable composition such as for example a curing catalyst and other additives for various enduse applications.

The curable composition of the present invention may include at least one epoxy compound as component (A) to form the epoxy matrix in a final curable formulation. For example, the epoxy compound useful in the present invention may include any conventional epoxy compound. One embodiment of the epoxy compound used in the curable composition of the present invention may be for example a single epoxy compound used alone; or a combination of two or more epoxy compounds known in the art. For example, useful epoxy compounds for preparing the curable composition include any of the epoxy resin compounds described above with regard to component (ii) used to prepare the polymeric adduct; or any of the epoxy resin compounds described in Lee, H. and Neville, K., Handbook of Epoxy Resins, McGraw-Hill Book Company, New York, 1967, Chapter 2, pages 2-1 to 2-27, incorporated herein by reference.

In a preferred embodiment, the epoxy compound for the curable composition may include for example bisphenol A diglycidyl ether such as D.E.R. 331®, bisphenol F diglycidyl ether such as D.E.R.® 354, or mixtures thereof. D.E.R. 331® and D.E.R. 354 are diglycidyl ether epoxy resins commercially available from The Dow Chemical Company that can be used to prepare the curable composition of the present invention.

Generally, the amount of epoxy resin compound used in the curable composition of the present invention, may be for example, from about 30 wt % to about 70 wt % in one embodiment, from about 40 wt % to about 60 wt % in another embodiment; and from about 45 wt % to about 55 wt % in still another embodiment, based on the total weight of all the components of the curable composition.

The hardener composition (also referred to in the art as a “curing agent” or “crosslinking agent”), component (B), includes the hardener formulation or composition of the present invention as described above.

In another embodiment, a co-curing agent in addition to the hardener composition of the present invention can be blended together to form the curing agent, component (B), that is blended with the epoxy resin compound, component (A), to prepare the curable composition. In this instance, any conventional curing agent can be used as the co-curing agent such as for example any amine hardener.

Generally, the amount of the hardener composition; or the combination of the hardener composition and co-curing agent, used in the curable composition of the present invention will depend on the enduse of the curable composition. For example, as one illustrative embodiment, the concentration of the hardener composition used to prepare the curable composition can be generally from about 15 wt % to about 45 wt % in one embodiment, from about 20 wt % to about 40 wt % in another embodiment; and from about 25 wt % to about 35 wt % in still another embodiment; based on the weight of all the components of the curable composition.

The curable composition of the present invention may include other optional compounds such as a curing catalyst to speed up the curing process of curable composition. Generally, the optional compounds that may be added to the curable composition of the present invention may include compounds that are normally used in resin formulations known to those skilled in the art for preparing curable compositions and thermosets. For example, the other optional compounds that may be added to the curable epoxy resin composition of the present invention may include additives generally known to be useful for the preparation, storage, application, and curing of epoxy resin compositions.

For example, other optional additives that can be included in epoxy resin curable composition of the present invention may be one or more of the following compounds: solvents, pigments, fillers, leveling assistants, and the like, or mixtures thereof. The solvent can be selected from, for example, ketones, ethers, aromatic hydrocarbons, glycol ethers, cyclohexanone and combinations thereof.

Generally, the amount of the optional additives used in the present invention may be in the range of from about 0 wt % to about 5 wt %, from about 0.01 wt % to about 4 wt % in another embodiment, and from 0.1 wt % to about 3 wt % in still another embodiment, based on the total weight of the resin forming components of the composition in one embodiment.

The process for preparing the curable composition of the present invention includes admixing at least (A) the at least one epoxy compound described above; (B) the at least one hardener composition described above, and (C) optionally, any other optional ingredient(s) as needed. For example, the preparation of the curable resin formulation of the present invention is achieved by blending, in known mixing equipment, the epoxy compound, the hardener composition, and optionally any other desirable additives. Any of the above-mentioned optional additives, for example a curing catalyst, may be added to the composition during the mixing or prior to the mixing to form the curable composition.

All the compounds of the curable formulation are typically mixed and dispersed at a temperature enabling the preparation of an effective curable epoxy resin composition having the desired balance of properties for a particular application. For example, the temperature during the mixing of all components may be generally from about 20° C. to about 80° C. in one embodiment, from about 25° C. to about 70° C. in another embodiment, and from about 30° C. to about 60° C. in still another embodiment. Lower mixing temperatures help to minimize reaction of the epoxide and hardener in the composition to maximize the pot life of the composition.

The preparation of the curable formulation of the present invention, and/or any of the steps thereof, may be a batch or a continuous process. The mixing equipment used in the process may be any vessel and ancillary equipment well known to those skilled in the art.

Some the beneficial properties or characteristics of the curable composition of the present invention include for example, (1) the curable composition has a viscosity to make the composition easily processable (e.g., the viscosity can be from about 200 millipascals-seconds (mPa-s) to about 20,000 mPa-s; and (2) the curable composition exhibits a reaction time sufficiently slow to allow the handling of materials for producing castings of larger volumes (e.g., volumes of >200 L).

Generally, the viscosity of the curable composition can be from about 200 mPa-s to about 20,000 mPa-s in one embodiment, from about 300 mPa-s to about 15,000 mPa-s in another embodiment, and from about 400 mPa-s to about 5,000 mPa-s in still another embodiment.

The curable composition also advantageously exhibits an extended pot life of greater than 35 and a low exotherm temperature of below 160° C.

Another embodiment of the present invention includes a process for curing the curable epoxy resin composition described above to form a thermoset or cured article. For example, the curable composition or formulation of the present invention can be cured under conventional processing conditions to form a film, a coating, or a solid. Curing the curable composition may be carried out at curing reaction conditions including a predetermined temperature and for a predetermined period of time sufficient to cure the composition. The curing conditions may be dependent on the various components used in the curable composition such as the curing agent used in the formulation.

For example, the temperature of curing the curable composition may be generally from about 10° C. to about 200° C. in one embodiment; from about 20° C. to about 100° C. in another embodiment; and from about 30° C. to about 80° C. in still another embodiment.

Generally, the curing time for the process of curing the curable composition may be chosen between about 10 minutes to about 4 hours in one embodiment, between about 5 minutes to about 2 hours in another embodiment, and between about 10 minutes to about 1.5 hours in still another embodiment. Below a period of time of about 10 minutes, the time may be too short to ensure sufficient reaction under conventional processing conditions; and above about 4 hours, the time may be too long to be practical or economical.

The cured product (i.e., the “cross-linked” product or “thermoset” product made from the curable composition) of the present invention can advantageously exhibit a combination and a balance of properties including properties such as for example processability, Tg, mechanical performance, thermal performance, and corrosion resistance. The cured product of the present invention can also advantageously exhibit a density lower than about 1 grams/cubic centimeter (g/cm³) in one embodiment and from about 0.2 g/cm³ to about 0.8 g/cm³ in another embodiment.

For example, the Tg of a thermoset made from the curable composition of the present invention is comparable to the Tg of a thermoset made from a conventional curable composition. That is, a curable epoxy resin composition containing the hardener composition of the present invention maintains a Tg at or near the Tg of a thermoset made from a conventional curable composition containing a conventional curing agent. For example, the difference in the Tg value of the cured product of the present invention versus the Tg value of a cured product cured with a conventional curing agent is generally no more than about 17% in one embodiment and is less than about 15% in another embodiment.

The Tg of a thermoset cured using the hardener composition of the present invention, as compared to using a conventional hardener, can be >50° C. in one embodiment, >60° C. in another embodiment and >75° C. in still another embodiment. Generally, the Tg of the thermoset made from the curable composition of the present invention may advantageously be in the range of from about 50° C. to about 150° C. in one embodiment, from about 60° C. to about 120° C. in another embodiment, and from about 70° C. to about 110° C. in still another embodiment. The Tg of the cured product can be measured by any well known methods. In the present invention, the curable composition is thermo analyzed with a Mettler Toledo DSC822, available from Mettler-Toledo Inc.; the actual glass transition temperature (Tg_{A}) is generally measured in the range of from about 20° C. to about 120° C. The potential glass transition temperature (Tg_{P}) is generally measured after post-curing for 10 minutes at 180° C.; the Tg_{P} can be in the range of from about 20° C. to about 130° C. and is measured following the procedure in Deutsches Institut für Normung (DIN German Institute for Standardization DIN 65467), at a heating rate of 15 degrees Kelvin/minute (° K/min).

Another improved property of the thermoset of the present invention over thermosets manufactured using conventional epoxy resins, may include for example, the cured product of the present invention exhibits reduced cracks caused by “hot-spots” (i.e., centers of high exotherm that lead to cracks).

The curable composition of the present invention may be used to manufacture a cured thermoset product such as syntactic foam, electronic materials, composites, coatings, films, laminates, and materials for marine applications.

In one preferred embodiment, the curable composition is used to manufacture syntactic foam for buoyancy modules. The syntactic foams of the present invention are lightweight composite materials of an epoxy resin matrix filled with hollow particles or microspheres bonded to the epoxy resin matrix. The epoxy resin matrix of the syntactic foam can be the curable epoxy resin composition described above; and the microspheres can be any of the well known microspheres known in the art. For example, the microspheres can be made from a variety of materials including glass microspheres, cenospheres, carbon, polymers, and the like. In a preferred embodiment, the syntactic foam is made with glass microspheres in an epoxy resin matrix formed from the curable composition of the present invention.

The glass microspheres can be made in a variety of sizes such as from about 500 nanometers (nm) to about 500 microns (μm).

The volume fraction of the glass microspheres used in the curable epoxy resin composition can vary depending on the effective density desired. For example, the volume fraction of microspheres can be from about 10 to about 90.

Advantageously, the syntactic foam made using the curable composition of the present invention in combination with the above described microspheres exhibits beneficial properties including for example a medium exotherm and a medium glass transition temperature of the syntactic foam. By “medium exotherm” with reference to the syntactic foam it is meant that the exotherm exhibited by the syntactic foam is generally from about <160° C. By “medium glass transition temperature” with reference to the syntactic foam it is meant that the Tg of the syntactic foam is generally about >50° C.

The compressive properties of syntactic foams can depend on the properties of the microspheres; and in general, the compressive strength of a material is proportional to its density. In one embodiment, the compressive strength of the syntactic foam of the present invention can be generally from about 5 Newton/square millimeter (N/mm²) to about 40 N/mm² and from about 10 N/mm² to about 30 N/mm² in another embodiment. The compressive strength of the syntactic foam of the present invention can be measured by the method described, for example, in ISO 178 (DIN 53452).

Another advantageous property of the syntactic foam can be tensile strength. The tensile strength can be influenced by the chemical makeup and properties of the epoxy matrix material used as the base resin in the curable epoxy resin composition of the present invention. For example, the tensile strength of the syntactic foam of the present invention can be generally from about 5 megapascals (MPa) to about 35 MPa in one embodiment and from about 10 MPa to about 30 MPa in another embodiment. The tensile strength of the syntactic foam of the present invention can be measured by the method described, for example, in ISO 604.

One advantage of using the curable composition of the present invention to manufacture syntactic foam articles and products is the curable composition provides the capability of producing thicker layers of useful syntactic foam for buoyancy modules than thicknesses previously produced using conventional epoxy resin curable compositions. For example, the thickness of the layers of syntactic foam that can be made using the curable composition of the present invention can be generally for example from about 10 cm to about 50 cm.

Another advantage of using the curable composition of the present invention to manufacture syntactic foam articles and products is the curable composition provides the capability of producing bigger modules of useful syntactic foam for buoyancy than those modules previously produced using conventional epoxy resin curable compositions. For example, the modules of syntactic foam that can be made using the curable composition of the present invention can be for example a size of from about 0.2 m³ to about 20 m³.

Still another advantage of using the curable composition of the present invention to manufacture syntactic foam articles and products is the curable composition provides the capability of producing syntactic foam for buoyancy modules in a single step. For example, the step of producing the syntactic foam includes mixing the hardener, resin and microspheres.

### EXAMPLES

The following examples and comparative examples further illustrate the present invention in detail but are not to be construed to limit the scope thereof.

Various terms and designations used in the following examples are explained herein below:

“HEW” stands for hydrogen equivalent weight.

“DSC” stands for dynamic scanning calorimetry.

“IPDA” stands for isophoronediamine.

“Tₘₐₓ” stands for maximum temperature.

“Tg” stands for glass transition temperature.

Nafol 1822 C is a C18/C22 fatty alcohol commercially available from Sasol.

Dionil 18 D is a C18 fatty (1,18) di-alcohol (1,18-Dihydroxyoctadecan; Octadecan (1,18) diol) commercially available from Sasol.

D-230 stands for Jeffamine D-230, which is a polyoxyalkylenediamine commercially available from Huntsman.

In addition to the above-described standard analytical equipment and methods used to measure properties, the following methods are used in the Examples:

EEW Measurements

“EEW” stands for epoxide equivalent weight. The EEW in grams/equivalent (g/equiv.) of an epoxy compound is measured according to the test method described in DIN 16945.

Dynamic Viscosity Test

The dynamic (dyn) viscosity at 25° C. (mPa-s) of an epoxy compound is measured at 25° C. according to the test method described in DIN 53018.

### Synthesis Example 1

### Preparation of a Polymeric Adduct

In this Synthesis Example 1, a polymeric adduct is prepared using a combination of a polyoxyalkylenepolyamine and an epoxy resin. The polymeric adduct is produced according to the following general procedure:

A flask is charged with 800 grams (g) of D-230. The material in the flask is heated to 120° C. and then 200 g of epoxy resin is charged dropwise into the flask under stirring. The temperature is kept at between 120° C. to 140° C. After complete addition of the epoxy resin, the resultant mixture is kept at between 120° C. to 140° C. for 120 minutes (min). After 120 min, a resulting polymeric adduct is formed.

The polymeric adduct, prepared as described above, had a viscosity of 700 mPa-s measured in accordance with the procedure described in DIN 53018. The polymeric adduct also had a calculated HEW of 87 g/equiv. The polymeric adduct product prepared by this Synthesis Example 1 is used to produce hardener compositions as described herein.

### Example 1

### Preparation of a Hardener Composition

The polymeric adduct (80 g) prepared as described above in Synthesis Example 1 is mixed with a monomeric unmodified amine, IPDA (10 g), for 2-10 min Then, to 90 g of the resulting mixture was added 10 g of an extender, Dionil 18 D; and the mixture was stirred for 10 min at 60° C. The resultant stirred mixture comprised a hardener composition useful for further preparing a curable composition as described herein.

### Comparative Examples A to E

### Preparation of Hardener Compositions

The same procedure described in Example 1 was used to prepare several hardener compositions except that the extender used was different and included a reference system (Comparative Example A), benzyl alcohol (Comparative Example B), a combination of Dionil 18D and Nafol 1822 C (Comparative Example C), styrenated phenol (Comparative Example D) and bisphenol A (Comparative Example E).

Each of the extenders prepared above were used to prepare a hardener composition by blending 10 g of each extender with 90 g of the polymeric adduct/monomeric unmodified amine mixture to form a hardener composition.

### Example 2

### Preparation of a Curable Composition

Each of the hardener compositions comprising a mixture of adduct/amine/extender prepared as described above were used to prepare a curable composition. To form the curable compositions, each of the hardener compositions was mixed with an appropriate amount of epoxy resin (56-58 g resin:28-29 g hardener) and glass microspheres. Each of the curable composition systems consisted of 87.5 wt % of the epoxy resin/hardener combination with 12.5 wt % glass microspheres. The glass microspheres used were 3M Scotchlite Glass Bubbles S 38 having a diameter of 30-120 μm and commercially available from 3M.

### Example 3

### Preparation of a Cured Composite

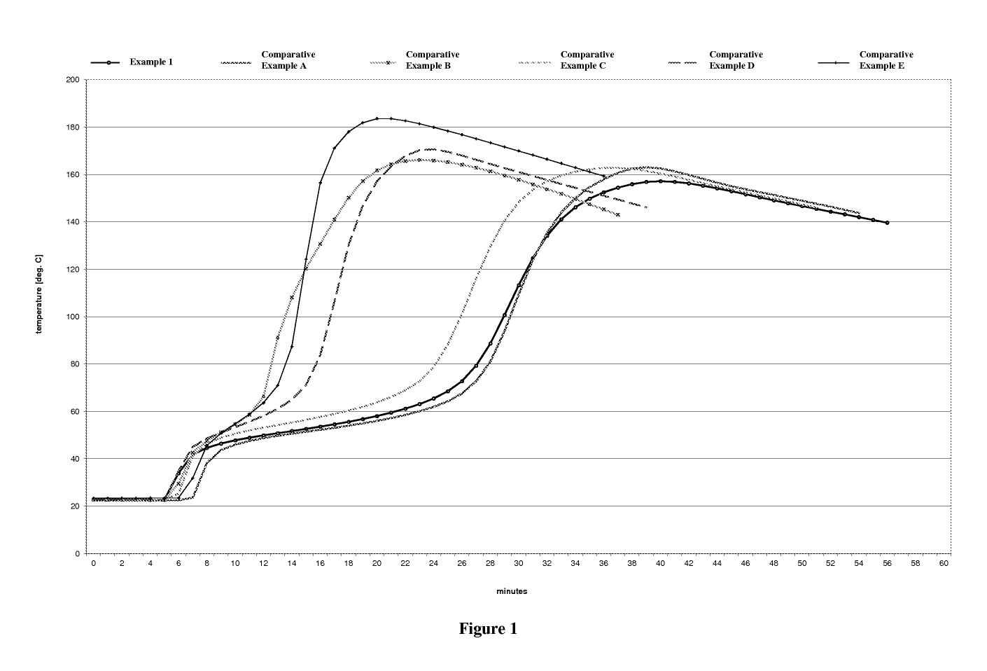

In this Example 3, several composite samples were produced using the curable compositions described above in Example 2; and the composites were tested to measure Tₘₐₓ and Tg. The time to reach Tₘₐₓ is considered to indicate reactivity and Tₘₐₓ should be as low as possible (e.g., <about 160° C.). The Tg was measured via DSC (2^{nd} run values). The results of the above tests are shown in the graphical illustration of FIG. 1.

For example, the reference system (Comparative Example A shown in FIG. 1 as a dotted line) shows a peak exotherm of 163° C. at 39 min and exhibits a Tg of 89.7° C. The curable composition of the present invention (Example 1 shown in FIG. 1 as a line with circle symbols) exhibits a peak exotherm of 157° C. at 40 min and exhibits a Tg of 75.2° C.

The results of the above Examples and Comparative Examples are shown in Tables I-IV as follows:

TABLE I
Adduct Hardener Compositions (75/25 D.E.H. 23/D.E.R. 331)

| | | Comparative | Comparative | Comparative | Comparative | Comparative |
|---|---|---|---|---|---|---|
| | Example 1 | Example A | Example B | Example C | Example D | Example E |
| Component | (%) | (%) | (%) | (%) | (%) | (%) |
| D.E.H. 23 | 62.44 | 69.375 | 62.44 | 62.44 | 62.44 | 62.44 |
| D.E.R. 331 | 20.81 | 23.125 | 20.81 | 20.81 | 20.81 | 20.81 |
| IPDA | 6.75 | 7.5 | 6.75 | 6.75 | 6.75 | 6.75 |
| Dionil 18D | 10 | | | 5 | | |
| Benzyl | | | 10 | | | |
| alcohol | | | | | | |
| Nafol 1822 C | | | | 5 | | |
| Styrenated | | | | | 10 | |
| phenol | | | | | | |
| Bisphenol A | | | | | | 10 |
| TOTAL | 100 | 100 | 100 | 100 | 100 | 100 |

TABLE II
Curable Compositions

| | | | Comparative | Comparative | Comparative | Comparative | Comparative |
|---|---|---|---|---|---|---|---|
| | | Example 1 | Example A | Example B | Example C | Example D | Example E |
| Ingredient | Component | (%) | (%) | (%) | (%) | (%) | (%) |
| Resin | D.E.R. 330 | 56.44 | 58.07 | 56.44 | 56.44 | 56.44 | 56.44 |
| Hardener | D.E.H. 23 | 19.58 | 20.14 | 19.58 | 19.58 | 19.58 | 19.58 |
| | D.E.R. 331 | 6.53 | 6.71 | 6.53 | 6.53 | 6.53 | 6.53 |
| | IPDA | 2.12 | 2.18 | 2.12 | 2.12 | 2.12 | 2.12 |
| | Dionil 18D | 2.44 | | | 1.22 | | |
| | Benzyl | | | 2.44 | | | |
| | alcohol | | | | | | |
| | Nafol 1822 C | | | | 1.22 | | |
| | Styrenated | | | | | 2.44 | |
| | phenol | | | | | | |
| | Bisphenol A | | | | | | 2.44 |
| Filler | 3M | 12.90 | 12.90 | 12.90 | 12.90 | 12.90 | 12.90 |
| | Scotchlite | | | | | | |
| | Glass | | | | | | |
| | Bubbles S38* | | | | | | |
| TOTAL | | 100.00 | 100.00 | 100.00 | 100.00 | 100.00 | 100.00 |

TABLE III
Peak Temperatures and Peak Time

| | | Comparative | Comparative | Comparative | Comparative | Comparative |
|---|---|---|---|---|---|---|
| | Example 1 | Example A | Example B | Example C | Example D | Example E |
| Minutes | (° C.) | (° C.) | (° C.) | (° C.) | (° C.) | (° C.) |
| 21 | 59.51 | 57.22 | 164.32 | 66.08 | 163.41 | 183.53 |
| 23 | 63.1 | 60.11 | 166.11 | 72.75 | 170.29 | 181.38 |
| 24 | 65.45 | 61.98 | 165.88 | 78.69 | 170.58 | 179.91 |
| 37 | 154.45 | 160.73 | 142.99 | 162.81 | 149.4 | |
| 39 | 156.83 | 163.10 | | 161.45 | 146.11 | |
| 40 | 157.14 | 162.56 | | 160.32 | | |

TABLE IV
Glass Transition Temperatures, Sample Pre-preparation:
DSC Method: 25° C.-180° C./10° C./min 2 times

| | | Comparative | Comparative | Comparative | Comparative | Comparative |
|---|---|---|---|---|---|---|
| | Example 1 | Example A | Example B | Example C | Example D | Example E |
| | (° C.) | (° C.) | (° C.) | (° C.) | (° C.) | (° C.) |
| Tg1 | 69.40 | 85.11 | 76.63 | 72.35 | 78.80 | 86.43 |
| Tg2 | 75.63 | 89.72 | 84.27 | 79.65 | 84.23 | 91.57 |
| Tg3 | 81.19 | 93.56 | 90.86 | 84.89 | 88.94 | 96.25 |

1. A hardener composition comprising:
(a) a polymeric adduct;
(b) a monomeric unmodified amine; and
(c) an extender.

2. The hardener composition of claim 1, wherein the hardener exhibits a reactivity level of greater than about 90 percent and wherein the hardener exhibits a peak exotherm temperature of is less than about 165° C.

3. The hardener composition of claim 1,
wherein the polymeric adduct comprises a reaction product of:
(i) a polyoxyalkylenepolyamine, and
(ii) an epoxy compound;
wherein the monomeric unmodified amine compound is cycloaliphatic diamine compound; and
wherein the extender is a long chain aliphatic fatty alcohol having from about C12 to about C30 carbon atoms.

4. The hardener composition of claim 3, wherein the polyoxyalkylenepolyamine is polyoxyethylene amine, polyoxypropylene amine, and mixtures thereof; wherein the epoxy compound is a difunctional aromatic diglycidylether; and wherein cycloaliphatic diamine compound is isophorone diamine.

5. The hardener composition of claim 3, wherein the epoxy compound is diglycidylether of bisphenol A; and wherein the extender is stearyl 1,18 di alcohol.

6. The hardener composition of claim 1, wherein the concentration of the polymeric adduct is from about 60 weight percent to about 90 weight percent; wherein the concentration of the monomeric unmodified amine compound is from about 1 weight percent to about weight percent; and wherein the concentration of the extender is from about 1 weight percent to about 20 weight percent.

7. A process for preparing a hardener composition comprising admixing:
(a) a polymeric adduct;
(b) a monomeric unmodified amine; and
(c) an extender.

8. The process of claim 7, wherein the admixing is carried out at a temperature of from about 20° C. to about 100° C.

9. A curable composition comprising:
(A) at least one epoxy compound; and
(B) at least one hardener, wherein the hardener comprises the hardener composition of claim 1.

10. The curable composition of claim 9, wherein the epoxide compound comprises a diglycidylether of bisphenol A.

11. The curable composition of claim 9, wherein the concentration of the epoxide compound is from about 30 weight percent to about 70 weight percent; and wherein the concentration of the hardener composition is from about 15 weight percent to about 45 weight percent.

12. A process for preparing a curable composition comprising admixing:
(A) at least one epoxy compound; and
(B) at least one hardener, wherein the hardener comprises the hardener composition of claim 1.

13. A process for preparing a thermoset comprising:
(i) providing a mixture of:
(A) at least one epoxy compound; and
(B) at least one hardener composition of claim 1; and
(ii) curing the curable composition of step (i).

14. The process of claim 13, wherein the curing step (ii) is carried out at a temperature of from about 10° C. to about 200° C.

15. A cured thermoset article prepared by the process of claim 13.
